(19) United States
(12) Patent Application Publication
(10) Pub. No.: US 2025/0178555 A1
(43) Pub. Date: Jun. 5, 2025

(54) OCCUPANT PROTECTION DEVICE

(71) Applicant: TOYODA GOSEI CO., LTD., Kiyosu-shi (JP)

(72) Inventor: Yuji MATSUZAKI, Kiyosu-shi (JP)

(21) Appl. No.: 18/926,746

(22) Filed: Oct. 25, 2024

(30) Foreign Application Priority Data
Dec. 5, 2023 (JP) 2023-205664

(51) Int. Cl. B60R 21/18; B60R 21/217; B60R 22/34

(52) U.S. Cl. CPC B60R 21/18; B60R 21/217; B60R 22/34

(57) ABSTRACT

A occupant protection device includes the following: a seat belt including a lap belt portion; an inflator that releases inflation gas; and an air bag provided in the lap belt portion, the air bag including: a bag body portion that is inflated by the inflation gas having been supplied to receive the occupant; and a conduit portion that is connected to the inflator and guides the inflation gas released from the inflator to the bag body portion, wherein the bag body portion includes a rear wall portion that faces the occupant when inflation is completed, the rear wall portion including a recess portion recessed forward while extending from a left end portion to a right end portion of the rear wall portion to penetrate in a left and right direction.

### CROSS-REFERENCE TO RELATED APPLICATIONS

The present application claims priority from Japanese Patent Application No. 2023-205664 of Matsuzaki, filed on Dec. 5, 2023, the disclosures of which are hereby incorporated into the present application by reference.

### BACKGROUND

### Technical Field

The present invention relates to an occupant protection device that protects an occupant seated on a seat of a vehicle.

### Description of Related Art

As an occupant protection device for protecting an occupant, a configuration has been conventionally and widely known in which a seat belt for restraining an occupant in a seat is provided. US 2019/0299899 A1 discloses a configuration in which an air bag is provided on a lap belt portion of a seat belt for restraining a waist of an occupant so that the occupant is received and protected by the air bag.

US 2019/0299899 A1 also discloses a configuration in which a recess portion recessed forward is provided in a rear wall portion of the air bag, the rear wall portion facing the occupant when the air bag is completely inflated. This configuration causes a facing part of the occupant that faces the recess portion to be less likely to come into pressure contact with the air bag when the air bag is completely inflated, so that the facing part of the occupant is prevented from being compressed by the air bag.

However, the recess portion disclosed in US 2019/0299899 A1 does not extend from a left end portion to a right end portion of the rear wall portion of the air bag, and exists only near the center of the rear wall portion in a left and right direction. Thus, when a vehicle obliquely collides and the occupant moves obliquely forward, the recess portion may be disposed while being laterally displaced with respect to a part to be protected of the occupant, the part being desired to be reduced in compression caused by the air bag. In this case, the compression caused by the air bag may not be appropriately reduced at the part to be protected of the occupant.

### SUMMARY

It is an object of the present invention to provide an occupant protection device capable of reducing compression caused by an air bag at a part to be protected of the occupant even when a vehicle obliquely collides and the occupant moves obliquely forward.

The occupant protection device according to the present invention has a typical configuration as described below.

The occupant protection device includes the following: a seat belt including a lap belt portion configured to restrain a waist of an occupant seated on a seat; an inflator that releases inflation gas; and an air bag provided in the lap belt portion, the air bag including: a bag body portion that is inflated by the inflation gas having been supplied to receive the occupant; and a conduit portion that is connected to the inflator and guides the inflation gas released from the inflator to the bag body portion to allow the inflation gas to flow into the bag body portion, wherein the bag body portion includes a rear wall portion that faces the occupant when inflation is completed, the rear wall portion including a recess portion recessed forward while extending from a left end portion to a right end portion of the rear wall portion to penetrate in a left and right direction.

### BRIEF DESCRIPTION OF THE DRAWINGS

FIG. 1 is a perspective view of a seat equipped with an occupant protection device.

FIG. 2 is a left side view of the seat.

FIG. 3 is a front view of the seat.

FIG. 4 is a left side view of the seat when an air bag is inflated.

FIG. 5 is a sectional view of a bag assembly taken along a line A-A illustrated in FIG. 3.

FIG. 6 is a perspective view of the bag assembly as viewed from below when the air bag is inflated.

FIGS. 7A and 7B are each a schematic diagram illustrating a positional relationship between an occupant and the air bag when a vehicle obliquely collides, or when the vehicle collides head-on in a state where the air bag is disposed while being laterally displaced with respect to the occupant.

FIG. 8 is a left side view illustrating a positional relationship between the occupant and the air bag when the vehicle collides.

### DESCRIPTION OF THE PREFERRED EMBODIMENTS

Preferred embodiments of the present invention are described below with reference to accompanying drawings. However, the invention is not limited to the embodiments disclosed herein. All modifications within the appended claims and equivalents relative thereto are intended to be encompassed in the scope of the claims.

Hereinafter, a general configuration of an occupant protection device 10 according to an embodiment of the present invention will be first described with reference to the drawings. Dimensions, materials, shapes, relative arrangements, and the like of components described below are not intended to limit the scope of the present invention only to them unless otherwise specified. In the following description, a left and right direction means a left direction and a right direction of a seat 1 equipped with the occupant protection device 10, specifically, the left direction and the right direction as viewed from an occupant M seated on the seat 1. A front and rear direction means a front direction and a rear direction of the seat 1, specifically, the front direction and the rear direction as viewed from the occupant M seated on the seat 1. An up and down direction means an upward direction and a downward direction in the vertical direction.

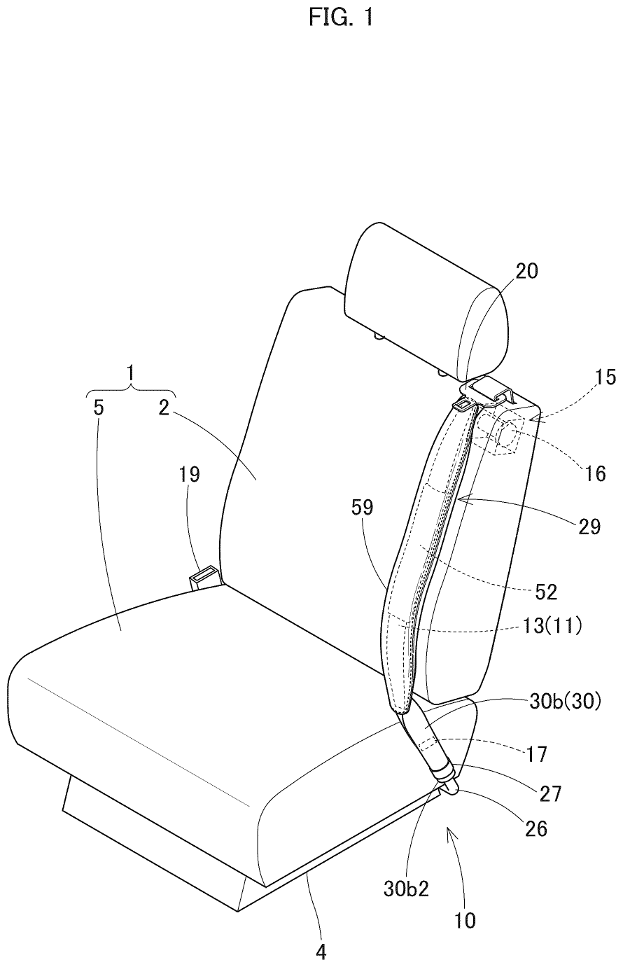

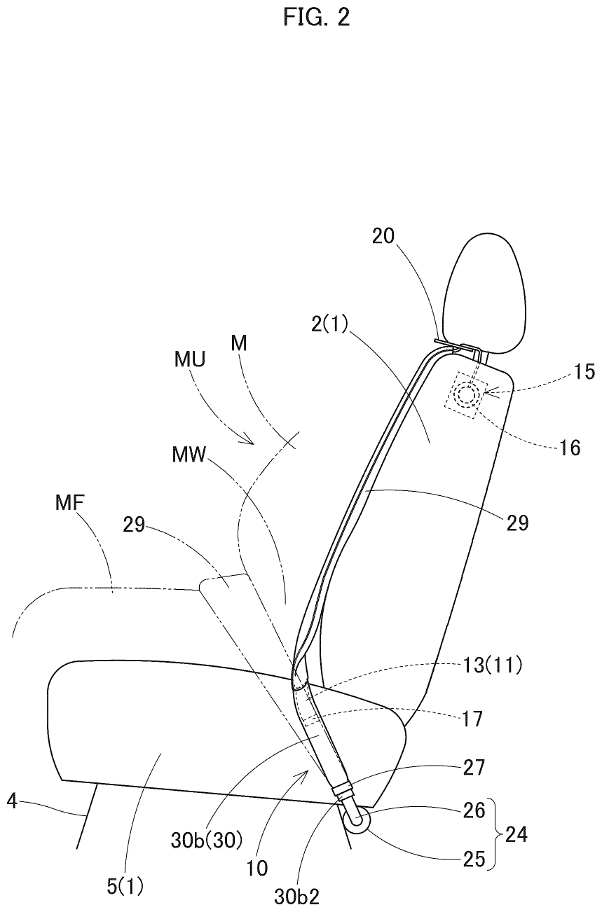

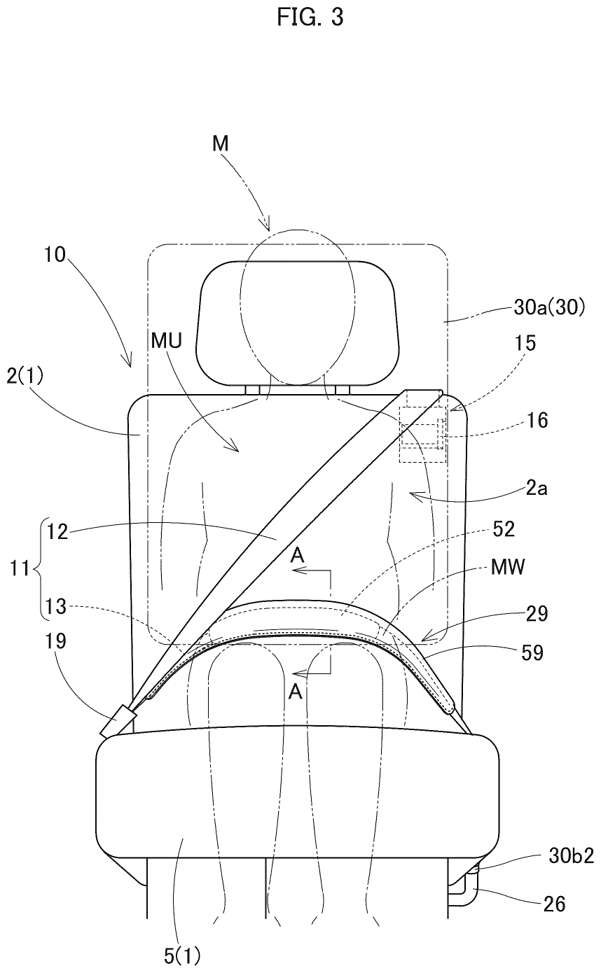

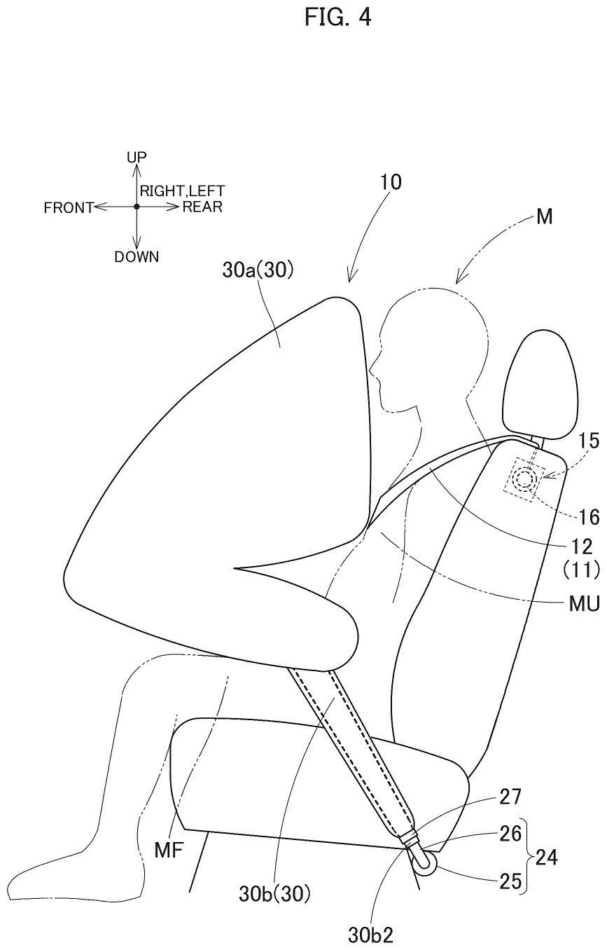

FIG. 1 is a perspective view of the seat 1 equipped with the occupant protection device 10. FIG. 2 is a left side view of the seat 1. FIG. 3 is a front view of the seat 1, and illustrates the occupant M seated on the seat 1 while wearing a seat belt 11, and an air bag 30 in an inflated state of the occupant protection device 10, which is drawn by a two-dot chain line. FIG. 4 is a left side view of the seat 1 with the air bag 30 inflated, and illustrates the occupant M seated on the seat 1 while wearing the seat belt 11, which is drawn by a two-dot chain line.

As illustrated in FIGS. 1 to 4, the occupant protection device 10 is mounted on the seat 1 of a vehicle and protects the occupant M seated on the seat 1. The occupant protection device 10 includes the seat belt 11, a bag assembly 29 including the air bag 30, and an inflator 24 that supplies inflation gas to the air bag 30. The seat 1 includes a backrest 2 and a seat bottom portion 5.

The seat belt 11 is a belt-shaped member that restrains the occupant M to the seat 1. The seat belt 11 is configured to be able to be fed out from a retracting mechanism 15 provided inside the backrest 2 at a position near a left upper edge of the backrest 2. The seat belt 11 includes a lower end portion serving as a fixed end fixed to an anchor member 17 provided on a left side of the seat bottom portion 5. The seat belt 11 is provided midway with a tongue 20. The tongue 20 is fastened to a buckle 19 provided on a right side of the seat bottom portion 5 of the seat 1. When the occupant M is seated on the seat 1 and the tongue 20 is fastened to the buckle 19, the seat belt 11 is worn by the occupant M.

The seat belt 11 worn by the occupant M includes a shoulder belt portion 12 extending from the tongue 20 toward the retracting mechanism 15 and disposed in front of an upper body MU of the occupant M to restrain the upper body MU of the occupant M, and a lap belt portion 13 extending from the tongue 20 toward the anchor member 17 and disposed in front of a waist MW of the occupant M to restrain the waist MW. That is, the lap belt portion 13 is configured to restrain the waist MW of the occupant M. The occupant M can release a state of the tongue 20 fastened into the buckle 19 and detach the tongue 20 from the buckle 19 by pressing a release button (not illustrated) provided on the buckle 19.

The retracting mechanism 15 includes a pretensioner mechanism 16 configured to stop feeding of the seat belt 11 when the seat belt is rapidly fed out, and to retract the seat belt 11 when the vehicle collides. The pretensioner mechanism 16 instantaneously winds the seat belt 11 by activating a built-in gas generator to rotate a shaft around which the seat belt 11 is wound.

The inflator 24 includes an inflator body 25 that discharges the inflation gas, and a pipe portion 26 that guides the inflation gas discharged from the inflator body 25 to the air bag 30. The inflator body 25 is attached to a seat frame 4 that supports the seat bottom portion 5 of the seat 1. The pipe portion 26 extends from the inflator body 25 and is bent in a substantially L shape along a side surface of the seat bottom portion 5 from a bottom surface thereof.

The bag assembly 29 includes an air bag 30 including a bag body portion 30a and a conduit portion 30b, a bag connecting portion 52 that connects the air bag 30 to the lap belt portion 13, and an air bag cover 59. Before the inflation gas is supplied from the inflator 24, the bag body portion 30a is housed inside the air bag cover 59 while being folded. The conduit portion 30b of the air bag 30 is connected to the pipe portion 26 of the inflator 24 to take in the inflation gas discharged from the inflator 24 and guide the inflation gas to the bag body portion 30a. The conduit portion 30b of the air bag 30 is connected at its base end portion 30b2 to the pipe portion 26 of the inflator 24 by being fastened by a clamp 27. A detailed configuration of each member constituting the bag assembly 29 will be described later.

Next, an operation of protecting the occupant M by the occupant protection device 10 will be described. When the vehicle collides, the pretensioner mechanism 16 of the retracting mechanism 15 is first activated to wind up the seat belt 11 worn by the occupant M, thereby stabilizing a sitting posture of the occupant M on the seat 1. As a result, the lap belt portion 13 of the seat belt 11 is drawn toward the tongue 20, and the shoulder belt portion 12 continuous from the lap belt portion 13 is drawn toward a shoulder of the occupant M.

Next, the inflator 24 is activated to supply the inflation gas from the inflator body 25 to the bag body portion 30a of the air bag 30 through the pipe portion 26 and the conduit portion 30b of the air bag 30. As a result, the bag body portion 30a inflates. After that, the bag body portion 30a receives the upper body MU of the occupant M moving forward due to impact of the collision of the vehicle. In this manner, the occupant protection device 10 protects the occupant M.

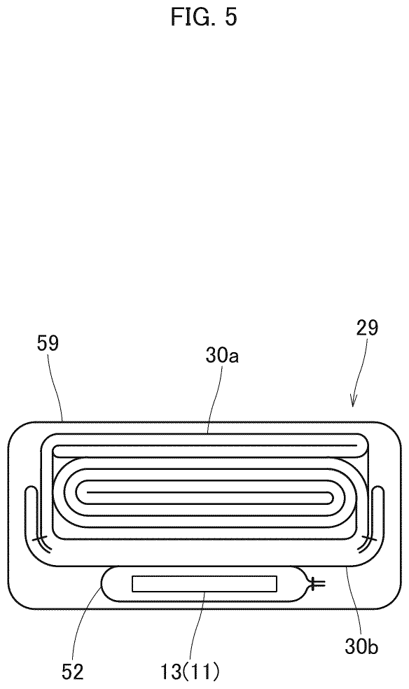

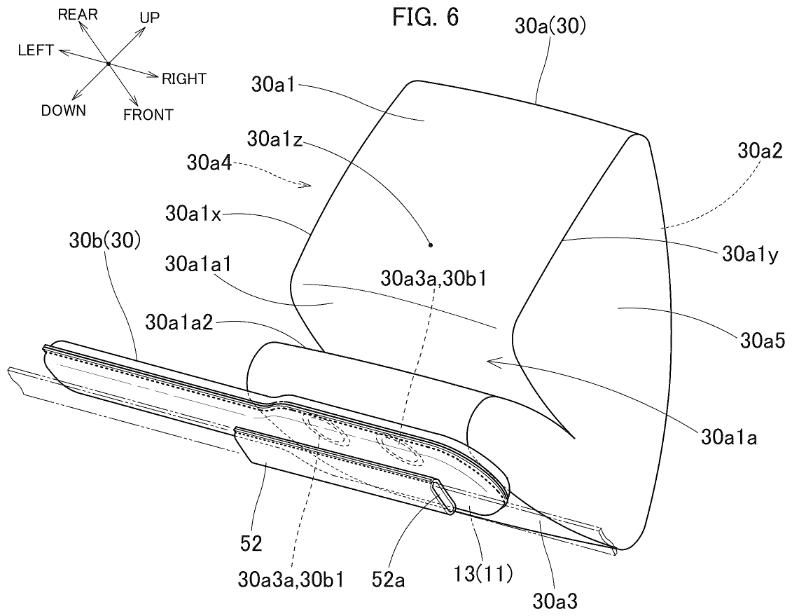

Next, each member constituting the bag assembly 29 will be described. FIG. 5 is a sectional view of the bag assembly 29 taken along a line A-A illustrated in FIG. 3. FIG. 6 is a perspective view of the bag assembly 29 as viewed from below when the air bag 30 is inflated, and the air bag cover 59 is not illustrated.

As illustrated in FIGS. 5 and 6, the air bag 30 includes the bag body portion 30a that is inflated when the inflation gas is supplied and receives the occupant M, and the conduit portion 30b that is connected to the pipe portion 26 of the inflator 24 and guides the inflation gas discharged from the inflator 24 to an inlet port 30a3a of the bag body portion 30a to allow the inflation gas to flow into the bag body portion 30a. The bag body portion 30a and the conduit portion 30b are each formed of a base fabric for a bag, which is a woven fabric made of polyester fibers woven by plain weave, and are connected by being sewn.

The bag body portion 30a when being completely inflated includes a rear wall portion 30a1 that is disposed immediately in front of the occupant M while facing the occupant M to come into contact with the upper body MU of the occupant M moving forward and receive the upper body MU, a front wall 30a2 that is disposed on a front side opposite to the rear wall portion 30al, a lower wall 30a3 that is disposed on a lower side and supported by the thigh MF of the occupant M, and a left wall 30a4 and a right wall 30a5 that are disposed on the left side and right side, respectively. When viewed from the left and right direction, the bag body portion 30a when being completely inflated has a substantially triangular shape with sides formed of the rear wall portion 30al, the front wall 30a2, and the left wall 30a4 or the right wall 30a5, except for a recess portion 30a1a of the rear wall portion 30al described later. The lower wall 30a3 of the bag body portion 30a includes two inlet ports 30a3a that are each an opening for allowing the inflation gas in the conduit portion 30b to flow in.

The rear wall portion 30a1 includes the recess portion 30a1a that is recessed forward and extends from a left end portion 30a1x to a right end portion 30a1y of the rear wall portion 30a1 to penetrate in the left and right direction. The recess portion 30a1a is defined by an inner wall 30a1a1 extending downward and forward, and an inner wall 30a1a2 extending downward and backward, and has a substantially V-shape with an opening backward as when viewed from the left and right direction. The recess portion 30a1a is disposed below a central part 30a1z of the rear wall portion 30a1 in the vertical direction. The recess portion 30a1a can be formed by cutting the base fabric for a bag before sewing into a shape capable of forming the recess portion 30a1a, or providing a tether inside the bag body portion 30a.

The conduit portion 30b is a tubular member connected to the pipe portion 26 of the inflator 24 and the bag body portion 30a, and extending along a longitudinal direction of the lap belt portion 13. The conduit portion 30b includes a communication port 30b1 communicating with the inlet port 30a3a of the bag body portion 30a. The inflation gas inside the conduit portion 30b flows into the inside of the bag body portion 30a through the communication port 30b1 and the inlet port 30a3a.

The bag connecting portion 52 is a tubular member made of a material similar to the base fabric for a bag forming the air bag 30, and connects the air bag 30 to the lap belt portion 13. The bag connecting portion 52 is connected on its upper surface to a lower surface of the conduit portion 30b of the air bag 30 by being sewn. The bag connecting portion 52 includes a tubular inner space serving as a belt insertion portion 52a through which the lap belt portion 13 is inserted. When the lap belt portion 13 is inserted into the belt insertion portion 52a, the air bag 30 is connected to the lap belt portion 13 with the bag connecting portion 52 interposed therebetween.

The air bag cover 59 is a tubular member attached to the lap belt portion 13. The air bag cover 59 houses inside the whole of the bag body portion 30a of the air bag 30 in a folded state, a part of the conduit portion 30b, the bag connecting portion 52, and a part of the lap belt portion 13. When the bag body portion 30a is inflated, the air bag cover 59 is broken by receiving pressure from the bag body portion 30a to form an opening, and then the bag body portion 30a is fed out through the opening.

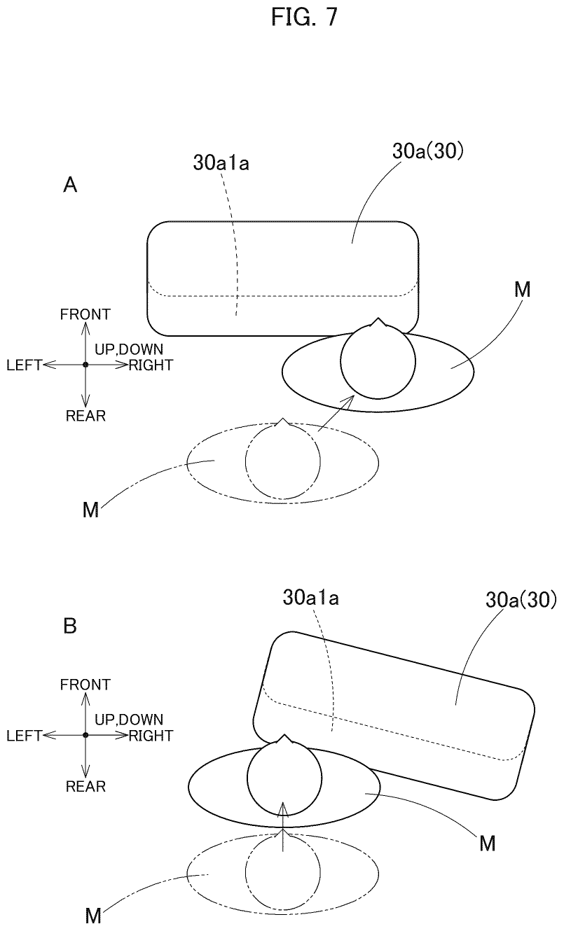

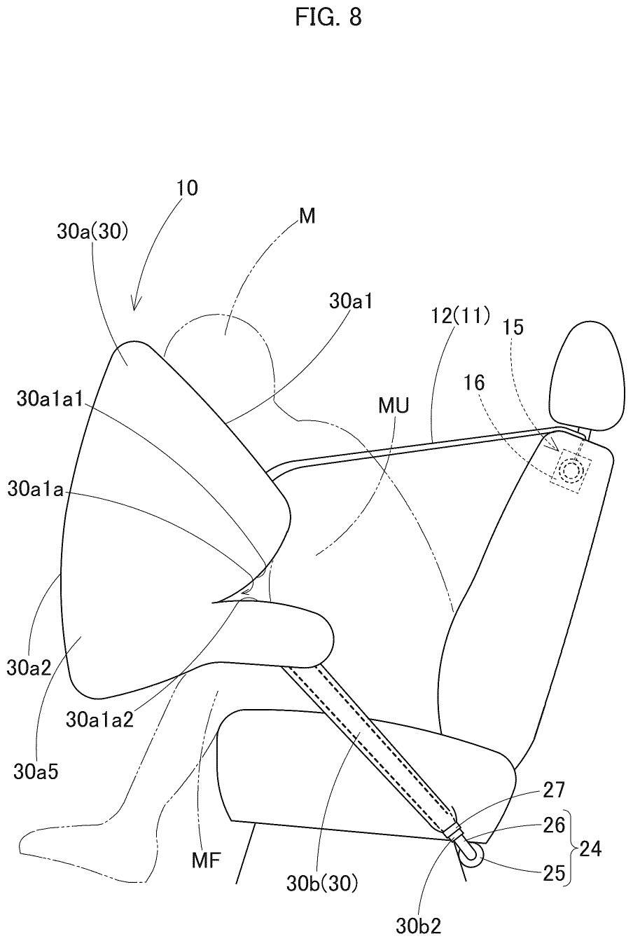

Next, a protection operation of the occupant protection device 10 when the vehicle obliquely collides will be described with reference to FIGS. 7A, 7B, and 8. FIG. 7A is a schematic diagram illustrating a positional relationship between the occupant M and the air bag 30 when the vehicle obliquely collides, and illustrates the occupant M and the air bag 30 as viewed from above. FIG. 8 is a schematic diagram illustrating a positional relationship between the occupant M and the air bag 30 when the vehicle collides, and illustrates a state in which the occupant M and the air bag 30 are viewed from the left side.

As illustrated in FIG. 7A, when the vehicle obliquely collides, the occupant M moves forward and rightward or leftward instead of moving straight forward. FIG. 7A illustrates a state in which the occupant M moves forward and rightward. In this case, when the recess portion 30a1a of the rear wall portion 30a1 of the bag body portion 30a is partially disposed near the center in the left and right direction without extending from the left end portion 30a1x to the right end portion 30a1y of the rear wall portion 30a1, the recess portion 30a1a may be disposed while being laterally displaced with respect to a part to be protected, such as the lower abdomen or the chest of the occupant M. This case may cause the part to be protected of the occupant M not to fit well in the recess portion 30a1a and to be pressed by the bag body portion 30a.

In contrast, the occupant protection device 10 of the present embodiment includes the recess portion 30a1a of the rear wall portion 30a1 of the bag body portion 30a, the recess portion 30a1a extending from the left end portion 30a1x to the right end portion 30a1y of the rear wall portion 30a1 to penetrate in the left and right direction. Thus, even when the vehicle obliquely collides and the occupant M moves obliquely forward, the recess portion 30a1a is prevented from being laterally displaced with respect to the part to be protected of the occupant M. As a result, the part to be protected of the occupant M easily fits within the recess portion 30a1a to enable reduction in compression of the bag body portion 30a on the part to be protected. This configuration is particularly effective for the occupant M such as a pregnant female who has a large abdominal circumference and requires protection of the lower abdomen. The configuration of the present embodiment is similarly effective for not only when the vehicle obliquely collides but also when the vehicle collides head-on and the air bag 30 is inflated in a state where the bag body portion 30a is disposed with the center position in the left and right direction that is laterally displaced with respect to the occupant M as illustrated in FIG. 7B.

The bag body portion 30a of the present embodiment includes the recess portion 30a1a, so that a part into which the inflation gas flows of the bag body portion 30a is reduced in volume as compared with a configuration without the recess portion 30a1a or a configuration in which the recess portion 30a1a is partially disposed near the center of the rear wall portion 30a1 in the left and right direction. Thus, the occupant protection device 10 of the present embodiment enables reduction in time from when the bag body portion 30a starts to inflate to when inflation is completed, so that the occupant M can be more safely protected.

Additionally, the recess portion 30a1a is disposed below the central part 30a1z in the vertical direction of the rear wall portion 30al. This configuration allows the recess portion 30a1a of the present embodiment to facilitate appropriate protection of the lower abdomen and the chest, which are each a part to be protected, of the occupant M. That is, when the vehicle collides, the occupant M is likely to be in a forward tilting posture during forward movement as illustrated in FIG. 8. Thus, the recess portion 30a1a disposed as described above allows not only the lower abdomen of the occupant M to be likely to be fit in the recess portion 30a1a before the occupant M takes the forward tilting posture, but also the chest thereof to be likely to be fit in the recess portion 30a1a after the occupant M takes the forward tilting posture. As a result, the lower abdomen and the chest of the occupant M, which are each a part to be protected, are likely to be appropriately protected. When the air bag 30 is provided in the lap belt portion 13, the lower abdomen and the chest are parts of the occupant M, the parts being likely to be compressed by the air bag 30, and thus highly requiring reduction in compression on the parts. However, when the neck or the like of the occupant M is set as the part to be protected by the recess portion 30a1a, for example, the recess portion 30a1a may be disposed above the central part 30a1z of the rear wall portion 30a1 in the vertical direction.

In the present embodiment, the configuration has been described in which the recess portion 30a1a is defined by the inner wall 30a1a1 and the inner wall 30a1a2, and has a substantially V-shape with an opening backward when viewed from the left and right direction. However, the present invention is not limited thereto, and the recess portion 30a1a may have another shape as long as the recess portion 30a1a extends from the left end portion 30a1x to the right end portion 30a1y of the rear wall portion 30a1 to penetrate in a left and right direction. For example, the effect described above can be similarly obtained by even a configuration in which the inner wall 30a1a1 and the inner wall 30a1a2 are formed as one curved surface, and the recess portion 30a1a has an arc shape when viewed from the left and right direction.

Although the occupant protection device 10 has been described by exemplifying the seat belt 11 of a so-called three-point type in which the seat belt 11 includes the shoulder belt portion 12 and the lap belt portion 13 in the present embodiment, the present invention is not limited thereto. That is, even when the present invention is applied to a seat belt 11 of a so-called two-point type in which the seat belt 11 includes the lap belt portion 13 without including the shoulder belt portion 12, the effect described above can be similarly obtained.

What is claimed is:

1. An occupant protection device comprising:
a seat belt including a lap belt portion configured to restrain a waist of an occupant seated on a seat;
an inflator that releases inflation gas; and
an air bag provided in the lap belt portion,
the air bag including:
a bag body portion that is inflated by the inflation gas having been supplied to receive the occupant; and
a conduit portion that is connected to the inflator and guides the inflation gas released from the inflator to the bag body portion to allow the inflation gas to flow into the bag body portion,
wherein the bag body portion includes a rear wall portion that faces the occupant when inflation is completed, the rear wall portion including a recess portion recessed forward while extending from a left end portion to a right end portion of the rear wall portion to penetrate in a left and right direction.

2. The occupant protection device according to claim 1, wherein the recess portion is disposed below a central part of the rear wall portion in a vertical direction.

3. The occupant protection device according to claim 1, further comprising a retracting mechanism capable of retracting the seat belt,
wherein the inflator and the retracting mechanism are mounted on the seat.
